(19) United States
(12) Patent Application Publication
(10) Pub. No.: US 2025/0320715 A1
(43) Pub. Date: Oct. 16, 2025

(54) COMPACT COLLAPSIBLE FOLDING SPACE ENCLOSURE WITH TELESCOPIC LIFTING CENTRAL STRUCTURE

(71) Applicant: George Sharpton, Lithonia, GA (US)

(72) Inventor: George Sharpton, Lithonia, GA (US)

(21) Appl. No.: 19/176,728

(22) Filed: Apr. 11, 2025

Related U.S. Application Data
(60) Provisional application No. 63/632,724, filed on Apr. 11, 2024.

(51) Int. Cl. E04B 1/344; B64G 99/00

(52) U.S. Cl. CPC E04B 1/3442; B64G 99/00

(57) ABSTRACT

A collapsible space enclosure system is disclosed, designed for efficient transport and deployment in the field of mechanical engineering. The system described addresses the technical problem of cumbersome and inefficient collapsible structures by providing a system that integrates a telescopic lifting central section with an upper and lower portion for balanced vertical retraction and extension. The system includes folding panels connected to the central structure, configured to fold in two for compact shipment. Actuators enable continuous 360° rotation and balanced vertical movement. Parallelogram linkage assemblies facilitate simultaneous lateral retraction and vertical lifting. Retractable strut channel assemblies allow for the installation of add-on retractable spaces, increasing floor area. This system is particularly useful for military, commercial, and recreational applications, offering a streamlined and versatile solution for rapid deployment and compact storage.

### CROSS REFERENCE TO RELATED APPLICATION

This application claims the benefit of priority of U.S. provisional application No. 63/632,724, filed Apr. 11, 2024, the contents of which are herein incorporated by reference.

### BACKGROUND OF THE SUBJECT DISCLOSURE

The present disclosure relates to mechanical engineering, specifically to collapsible space enclosures with telescopic lifting mechanisms for efficient transport and deployment.

In the field of collapsible space enclosures, there is a growing demand for structures that can be efficiently transported and deployed with minimal assembly. Traditional solutions often require extensive on-site assembly, which can be time-consuming and labor-intensive. These existing structures typically lack the ability to compactly fold and unfold, limiting their practicality for applications where rapid deployment and compact storage are highly desirable.

Current designs also struggle with achieving a balance between structural integrity and ease of transport. Many existing enclosures do not effectively integrate mechanisms for both vertical retraction and lateral folding, resulting in cumbersome and inefficient systems. This has created a need for an innovative approach that addresses these challenges, providing a more streamlined and versatile solution for various applications, including military, commercial, and recreational uses.

As can be seen, there is a need for a compact collapsible folding space enclosure with telescopic lifting central structure.

### SUMMARY OF THE SUBJECT DISCLOSURE

In one aspect of the subject disclosure, a collapsible enclosure system for efficient transport and deployment provides the following: a telescopic lifting central core including an upper portion and a lower portion configured for balanced vertical retraction and extension; a plurality of folding elements includes at least one folding wall element and one folding floor element, which are connected to the telescopic lifting central structure and configured to fold in two for compact shipment; a plurality of actuators including at least one rotary actuator and at least one linear actuator positioned on the folding elements and the telescopic lifting central core, wherein the actuators are arranged to provide continuous 360° rotation of the folding elements and balanced vertical movement of the central core; a plurality of parallelogram linkage assemblies mechanically coupling the telescopic lifting central section and the folding elements to facilitate simultaneous lateral retraction and vertical lifting of unit components; and a plurality of retractable strut channel assemblies attached to the folding elements configured to enable installation of add-on retractable spaces for increased floor area; and an offset-hinge interconnected between adjacent pairs of folding wall element and folding floor elements, wherein each offset-hinge works independent of the telescopic lifting core structure.

In another aspect of the subject disclosure, a method for deploying a compact collapsible folding enclosure for efficient transport and deployment includes the following steps: providing a telescopic lifting central structure including an upper portion and a lower portion configured for balanced vertical retraction and extension; providing a plurality of folding elements, including at least one folding wall element and one folding floor elements, connected to the telescopic lifting central structure and configured move between a folded condition for compact shipment and an unfolded condition for defining the enclosure; actuating a plurality of heavy-duty rotary actuators and linear actuators arranged on the folding panels and the telescopic lifting central structure to facilitate continuous 360° rotation of the folding elements and balanced vertical movement of the telescopic lifting central structure; engaging a plurality of parallelogram linkage assemblies to mechanically couple the telescopic lifting central section and the folding elements, facilitating simultaneous lateral retraction and vertical lifting of enclosure components; and engaging a plurality of retractable strut channel assemblies attached to the folding elements to enable installation of add-on retractable spaces for increased floor area of the enclosure; and engaging an offset-hinge interconnected between each adjacent pair of folding wall element and folding floor elements, wherein each offset-hinge works independent of the telescopic lifting core structure.

In yet another embodiment of the subject disclosure, a method for deploying a compact collapsible folding enclosure for efficient transport and deployment includes the following: wherein banks of multiple heavy-duty electric linear actuators mounted at the lower floor on both ends of the central core are used to overcome the challenges of vertical telescopic lifting of the central core as and a parallelogram lateral displacement of end wall panels of the upper central core and the later movement of collapsible wall, roof and floor panels, wherein heavy-duty electric rotary actuators are attached along and in alignment with the hinge axis of pivotally connecting floor, floor wall and roof panel parallel to the central core and on bi-folding end wall panels mounted on folding outer core floor panels perpendicular to the central core on both ends of the unit; further including installing heavy-duty electric rotary actuators aligned with heavy-duty strut metal hinges at mid-panel height on the end walls installed perpendicular to the units central core atop folding floor panels at sides of the central core floor panel to enable folding enable folding of the end wall panels to achieve shortening the overall length of the folded unit, wherein a parallelogram bar is installed on the vertically lifting end joist frame of the attics central core for balanced lifting of the central core with wire cables at the both ends of fixed strut frame at central core floor and at the upper end core walls, and a parallelogram installed below the moving end floor joist of the laterally extending room joist frame an attached to the fixed floor frame below at the central core, wherein the use of offset heavy-duty strut off set hinge and flange stiffener assembly to allow for a full 360-degrees continuous rotation of the on folding floor-to-wall hinged panel connection with the aid of heavy-duty rotary actuator; further including unfolding a transportable space enclosure mounted on a lowbed trailer in that back-to-back extendable strut channels post columns with trolleys attached to the base of joist framing with heavy-duty strut hinges in at least two rows at approximately two feet on center in such manner that they free swing downward to stand vertical until strut base anchor plates with open faces are slid into place at each post as a temporary means of supporting the unit floor, where shear panels are then field installed in both lateral and longitudinal directions; and uniformly cutting strut column posts to a length of approximately fourteen inches extend from the hinge fastened to bottom of the unfolded floor joist frame to a leveled pre-installed concrete slab or sloped terrain on site on both sides of the unfolded unit's central core, wherein the lifting and lowering of the roof, wall and floor panels about the central core via electric chain hoists attached to metal framed fulcrums with intermittently filled water tanks mounted atop retractable strut channel assemblies that when tanks are full will lift and lower the hinged series of panels in a rotary manner about the central core, wherein he hoist frame assembly is mounted on both ends of the hoist fulcrum assembly and move laterally to alternately clear both sides of the roof's edge to enable rotary lifting of the panels at separate times, and wherein the hooks of the chain hoist are connected to eyebolts mounted to a metal frame along the outer edge of the folding roof panel, wherein the unit has retractable folding floor, wall and roof panels with end wall panels assemblies are attached to both ends of the central perpendicular side wall panel onto which the end wall panels fold and this assembly then folds down onto the hinged floor panel, wherein the wall and floor panel assembly then folds upward to move laterally as a retractable folded assembly. The folding hinged roof panel covering this assembly is extended down from the outer folding roof frame above on retractable telescopic channels struts channels extending into the core of the lower folding panel, and then folding downward to fasten to cover the upward folding floor frame of the folded assembly during shipment by means of heavy-duty hinges that also attach to unfolded wall panels when the unit is erected, and wherein a f rotating extending fold-a-way panel folded panel assembly support post is attached to folding floor panel with folding diagonal bracing having retractable parallelograms attached to two or more upper folding diagonal steel brace channel segments which is controlled by electric linear actuators with the extending end of the actuator that moves a tubular steel channel up and down to cover the post support frame cover the folding ends of the diagonal brace to form a locked extended bracing when the floor support frame post is unfolded in a manually operated coupling for a locked brace assembly as with conventional manually operated diagonal table bracing, wherein the wire ends of the airline cables of the parallelogram are attached to the opposite ends of the strut frame post supporting both ends of the folding outer floor frames, and wherein the flashing membrane for the hinged folding roof, wall and floor panels of this folding unit are those that cover the entire surface of the hinged panel interface and is less-than-one-inch thick neoprene rubber membrane with at least two equal folding on-folding sides such that when panels are folded the membrane forms a continuous sealed channel with a compressible neoprene rubber bulb along the entire perimeter of the folded membrane, wherein the membrane is designed to keep water and air out of the joint and thereby aid in weather-proofing the folding unit in conjunction with the weather proof folded d panels similar to that of a closed car door, wherein the folded unit is to be covered with a durable heavy-duty rubber membrane during shipment on a low bed trailer.

These and other features, aspects and advantages of the present subject disclosure will become better understood with reference to the following drawings, description and claims.

### BRIEF DESCRIPTION OF THE DRAWINGS

FIG. 1 is a perspective view of an exemplary embodiment of the subject disclosure.

FIG. 2 is a perspective view of an exemplary embodiment of the subject disclosure.

FIG. 3 is a perspective view of an exemplary embodiment of the subject disclosure.

FIG. 4A is a perspective view of an exemplary embodiment of the subject disclosure.

FIG. 4B is a perspective view of an exemplary embodiment of the subject disclosure.

FIG. 5 is a perspective view of an exemplary embodiment of the subject disclosure.

FIG. 6 is a perspective view of an exemplary embodiment of the subject disclosure.

FIG. 7 is an elevation view of an exemplary embodiment of the subject disclosure.

FIG. 8 is an elevation view of an exemplary embodiment of the subject disclosure.

FIG. 9 is a perspective view of an exemplary embodiment of the subject disclosure.

FIG. 10 is a perspective view of an exemplary embodiment of the subject disclosure.

FIG. 11 is a perspective view of an exemplary embodiment of the subject disclosure.

FIG. 12 is a perspective view of an exemplary embodiment of the subject disclosure.

FIG. 13 is a perspective view of an exemplary embodiment of the subject disclosure.

FIG. 14 is a perspective view of an exemplary embodiment of the subject disclosure.

FIG. 15 is a perspective view of an exemplary embodiment of the subject disclosure.

FIG. 16 is a perspective view of an exemplary embodiment of the subject disclosure.

FIG. 17 is a perspective view of an exemplary embodiment of the subject disclosure.

FIG. 18 is a perspective view of an exemplary embodiment of the subject disclosure.

FIG. 19 is an elevation view of an exemplary embodiment of the subject disclosure.

FIG. 20 is an elevation view of an exemplary embodiment of the subject disclosure.

FIG. 21 is an elevation view of an exemplary embodiment of the subject disclosure.

FIG. 22 is an elevation view of an exemplary embodiment of the subject disclosure.

FIG. 23 is a perspective view of an exemplary embodiment of the subject disclosure.

FIG. 24 is a perspective view of an exemplary embodiment of the subject disclosure.

FIG. 25 is a perspective view of an exemplary embodiment of the subject disclosure.

FIG. 26 is a detailed perspective view of an exemplary embodiment of the subject disclosure.

FIG. 27 is a perspective view of an exemplary embodiment of the subject disclosure.

FIG. 28 is a perspective view of an exemplary embodiment of the subject disclosure.

FIG. 29 is a detailed perspective view of an exemplary embodiment of the subject disclosure.

FIG. 30 is a perspective view of an exemplary embodiment of the subject disclosure.

FIG. 31 is a perspective view of an exemplary embodiment of the subject disclosure.

FIG. 32 is a perspective view of an exemplary embodiment of the subject disclosure.

FIG. 33 is a perspective view of an exemplary embodiment of the subject disclosure.

FIG. 34 is a perspective view of an exemplary embodiment of the subject disclosure.

FIG. 35 is a perspective view of an exemplary embodiment of the subject disclosure.

FIG. 36 is a perspective view of an exemplary embodiment of the subject disclosure.

FIG. 37 is a perspective view of an exemplary embodiment of the subject disclosure.

FIG. 38 is a perspective view of an exemplary embodiment of the subject disclosure.

FIG. 39 is an exploded perspective view of an exemplary embodiment of a rubber flashing membrane of the subject disclosure.

FIG. 40 is a detailed view of an exemplary embodiment of an offset heavy-duty strut hinge 14 of the subject disclosure, shown in a collapsed condition, wherein the two opposing arms of the hinge are a zero-degrees orientation relative to each other.

FIG. 41 is a detailed view of an exemplary embodiment of the offset heavy-duty strut hinge 14 of the subject disclosure, shown in an extended condition, wherein the two opposing arms of the hinge are a 180-degrees orientation relative to each other.

### PART LIST OF THE DRAWINGS

1 Hydraulic Lifting Actuator
2 Remote-Controlled Heavy-Duty Linear Electric Actuator (removable)
2A Folding diagonal brace with sleeved extending tubular coupling lock with linear electric remote-controlled actuator as compared to conventional manually operated diagonal brace sleeved coupling locks
2B Metal tube sleeved diagonal brace coupling attached to a parallelogram
3. Strut Channel Anchor Plate
4. End joist of core lifting panel
5 Fold-a-way shear strut channel assembly with trolleys
6 Parallelogram (Bar) apparatus
6A Stainless steel airline parallelogram bar cable
7 Remote controlled (removable) electric rotary heavy-duty actuator with vane blade
8 End wall panel at attic level
8A Lower end wall panel at central core 8B Upper end wall panel at central core 9 End wall joist on lower floor panel
10 Anchor plate atop linear actuator
11 Main level floor panel at lower level
12 Door to central core at lower level
13 End wall panel at central core on lower level
14 Offset heavy-duty strut hinge and flange stiffener assembly 14A Shallow height metal flange stiffener strut channel
15 Heavy-duty strut panel-to-panel hinge
16 Removable shipping structural metal angle (temporarily installed on Central Core Floor beams and along outer beams of Upper Central Core Roof Beams to support folding floor, wall and roof panels during shipment.
17 Heavy-duty dual stage electric actuator assembly (removable)
18 Extending floor, wall and roof assembly for laterally extending folding space
18A Fixed floor strut fame below the central core along which trolleys on the extending trolley frame move
19 Longitudinal floor beam
20 End unit floor panel at lifting central core
21 Extending back-to-back Strut laterally extending retractable channels with trolleys at laterally extending folding space
22 Extending wall pane at fixed vertical core
23 Folding outer floor panel attached to central core and on folding wall panels attached with heavy-duty strut hinges and heavy-duty rotary actuators
24 Folding wall panel attached to on folding floor and roof panels with heavy-duty strut hinges and heavy-duty rotary actuators
25 Extending foldable wall panel at laterally extending folding space
26 Central core lateral outer beam attic level
27 Central core fixed beam at rising telescopic attic floor panel
28 Central core beam at outer folding roof panel
29 Central core upper fixed roof panel
30 Central core outer folding roof panel at on folding wall panel attached with heavy-duty strut hinges and removable heavy-duty rotary actuators
31 Central core fixed lower back shear wall panels
31A Central core fixed lower telescopic rising back shear wall panels
32 Telescopic back-to-back strut roof mounted hoist fulcrum support assembly
33 Roof hoist fulcrum (removable)
33A Water Tank Fulcrum (Filled as needed) (removable)
34 Roof hoist chain hook
35 Remote Controlled Electric Rotating Roof Panel hoist unit (removable)
37 Support beam at outer central core attached to on folding side wall panel
38 Beam at central core rising attic floor frame
39 Longitudinal Shear wall at lower central core
40 Fold-away bed/sofa
40A Fold away furniture (miscellaneous)
41 Hip roof framing rafters
42 Folding outer floor framing
43 End wall panel at centra core lower level
44A Bi-folding end wall panels attached to outer folding floor panels with heavy-duty strut hinges and heavy-duty rotary actuators
45 Lateral end support bean at upper central core
46 Vertical support end wall at end of upper central core
47 Intermediate lateral support beam atop lower dual stage actuator assembly
48 Steps up to toilet/kitchen module
49 Knee wall
50 Linear actuator mounted to central core roof to support offset extending upper core end wall panels
51 Strut Z shaped angle plate
52 Electric linear actuator located on extended central core roof to support offset extending upper core end wall panels
53 Heavy-duty roof hinge
54 Electric actuator support bar (removable)
55 Electric actuator support bar end piece
56 Electric actuator lower support bar
57 Kitchen range
58 ADA toilet
59 Kitchen Sink
60 Refrigerator
61 ADA Chairlift
62 Waste can
63 Low bed trailer
64 Neoprene Rubber Flashing

### DETAILED DESCRIPTION OF THE SUBJECT DISCLOSURE

The following detailed description is of the best currently contemplated modes of carrying out exemplary embodiments of the subject disclosure. The description is not to be taken in a limiting sense but is made merely for the purpose of illustrating the general principles of the subject disclosure, since the scope of the subject disclosure is best defined by the appended claims.

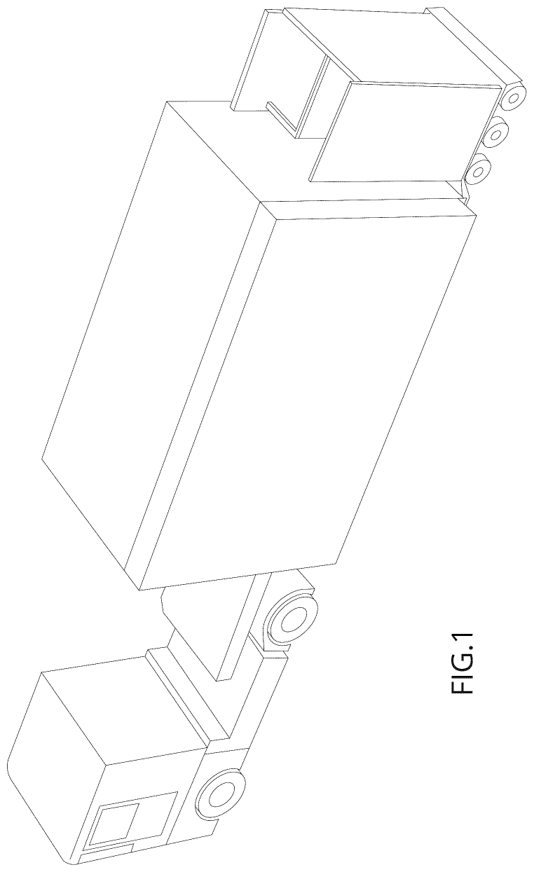

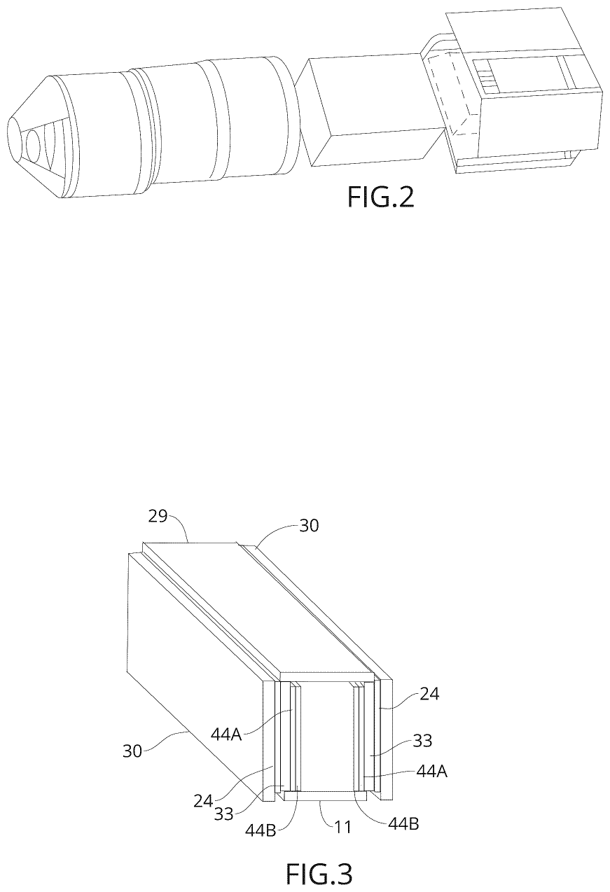

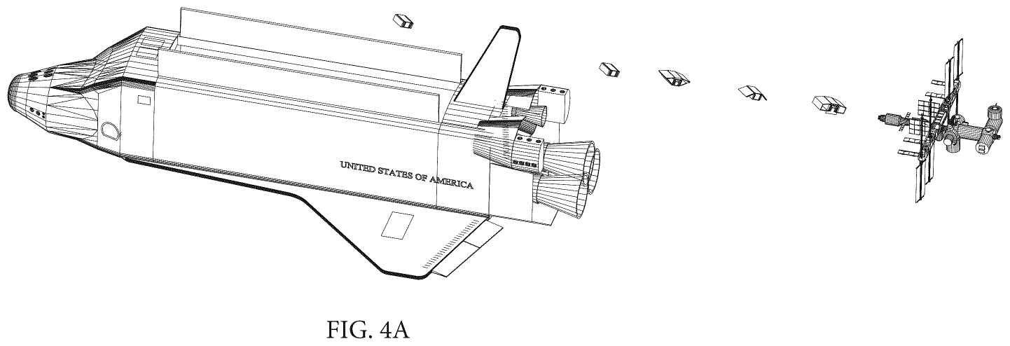

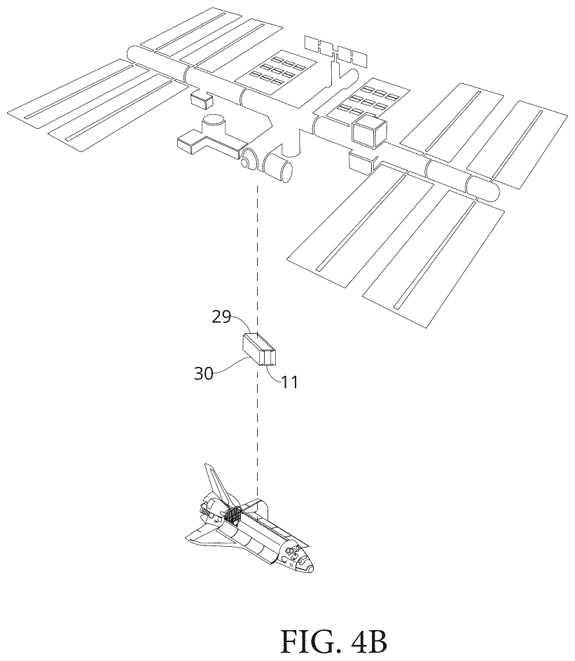

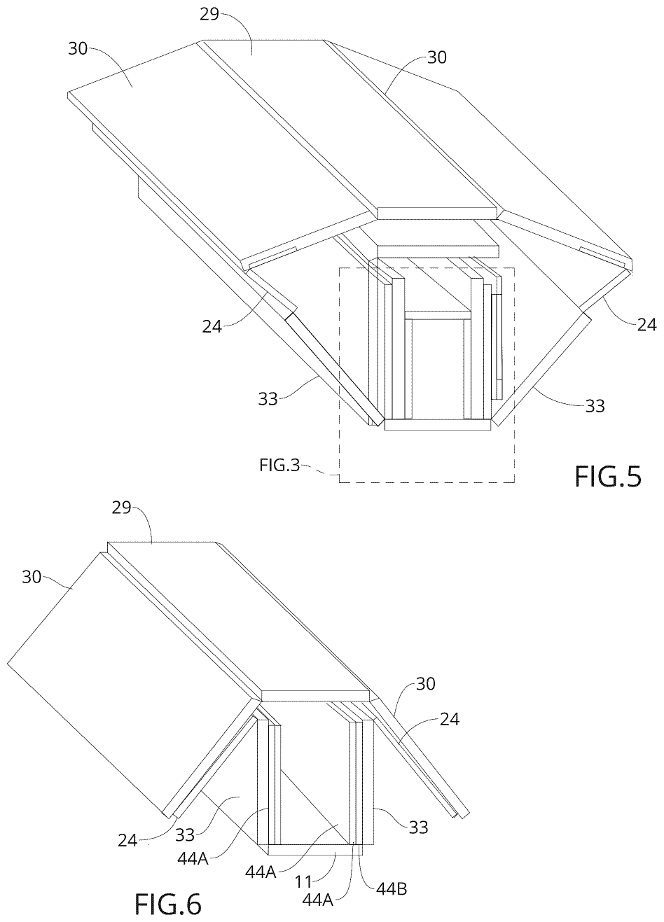

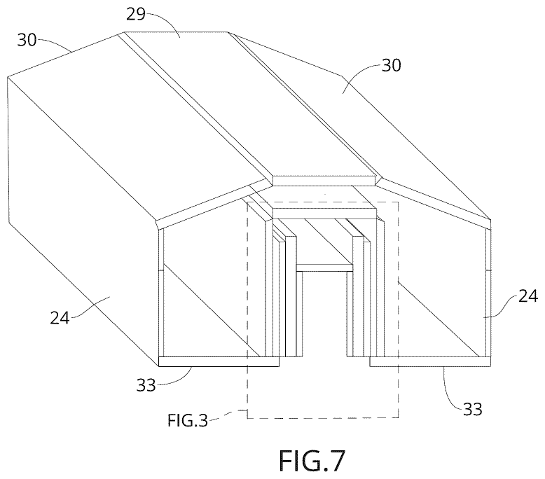

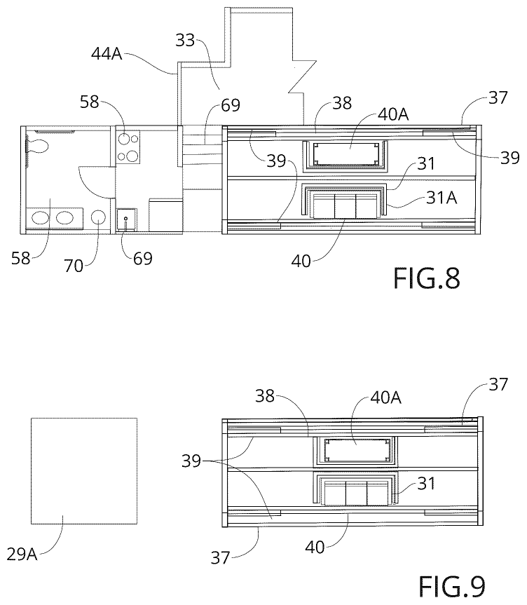

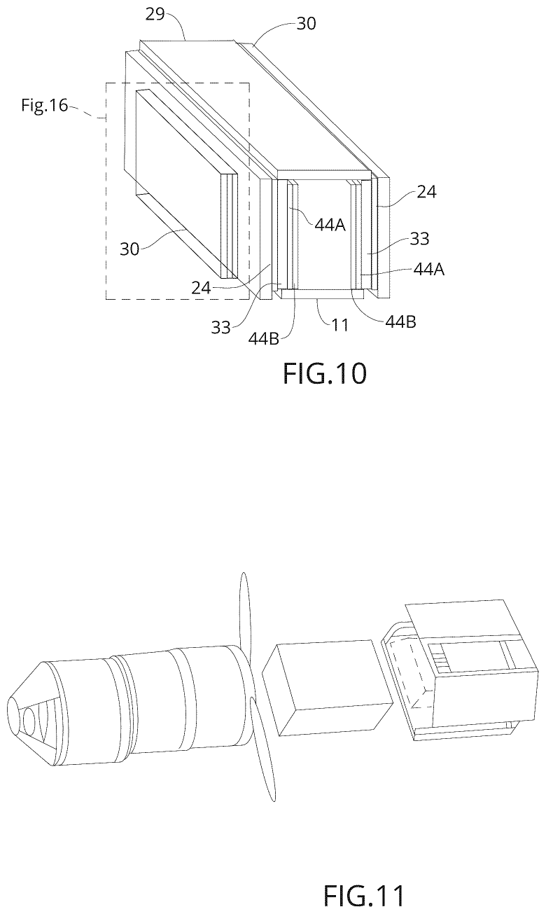

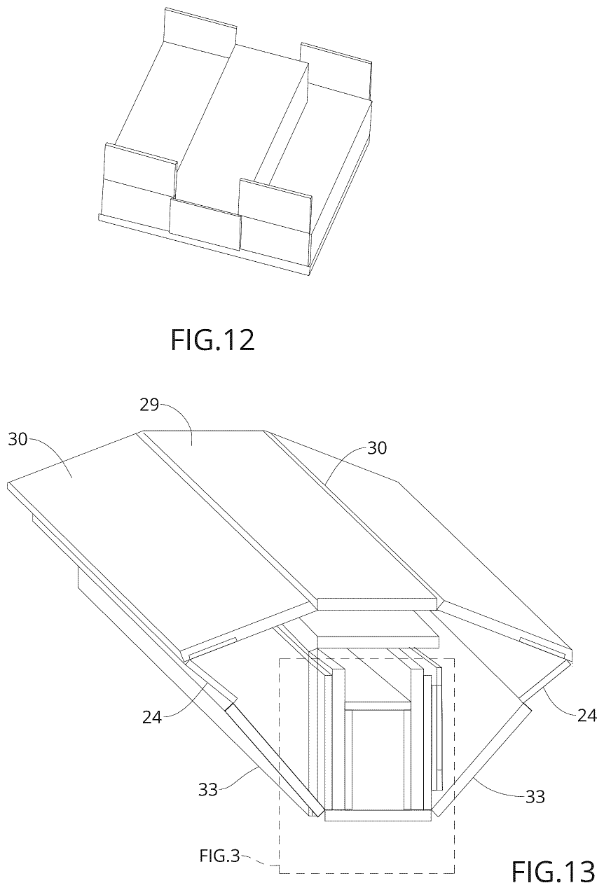

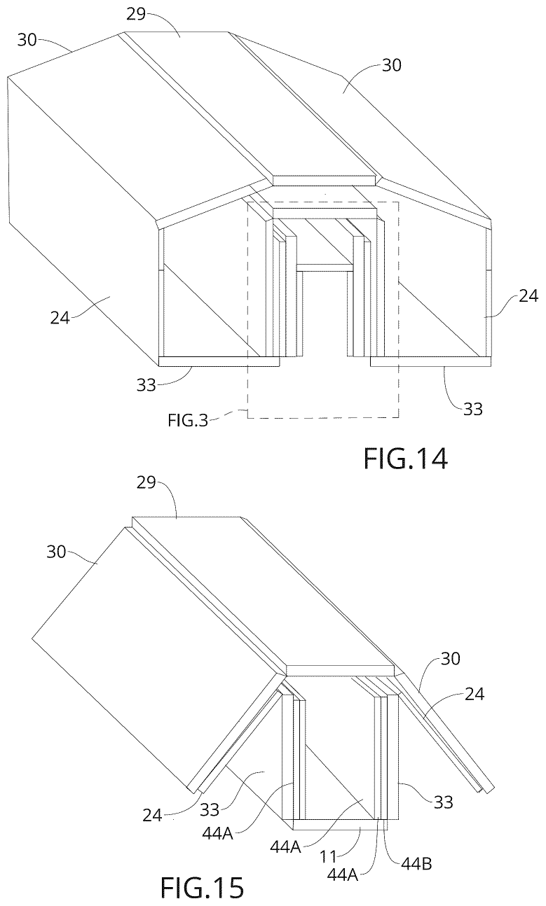

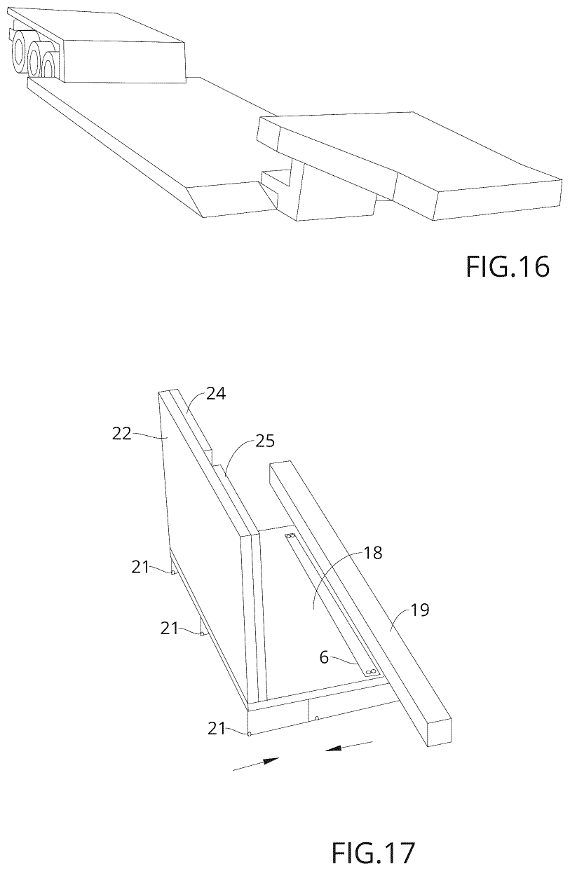

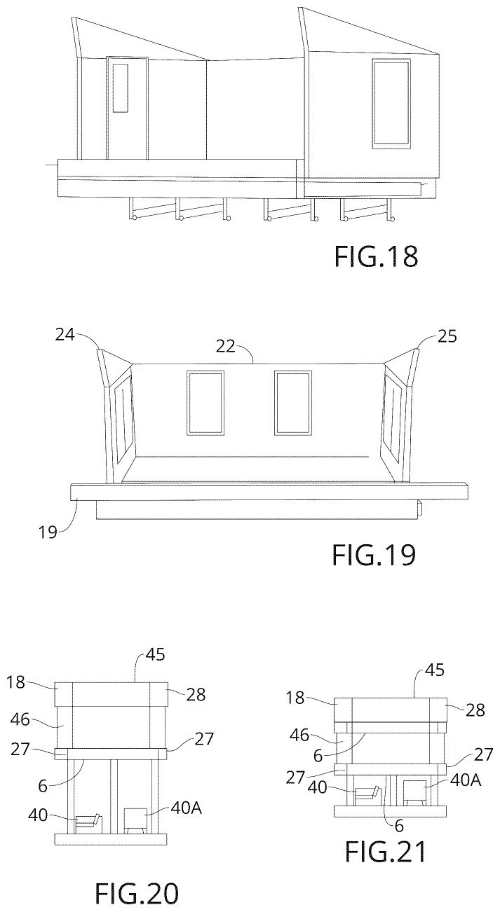

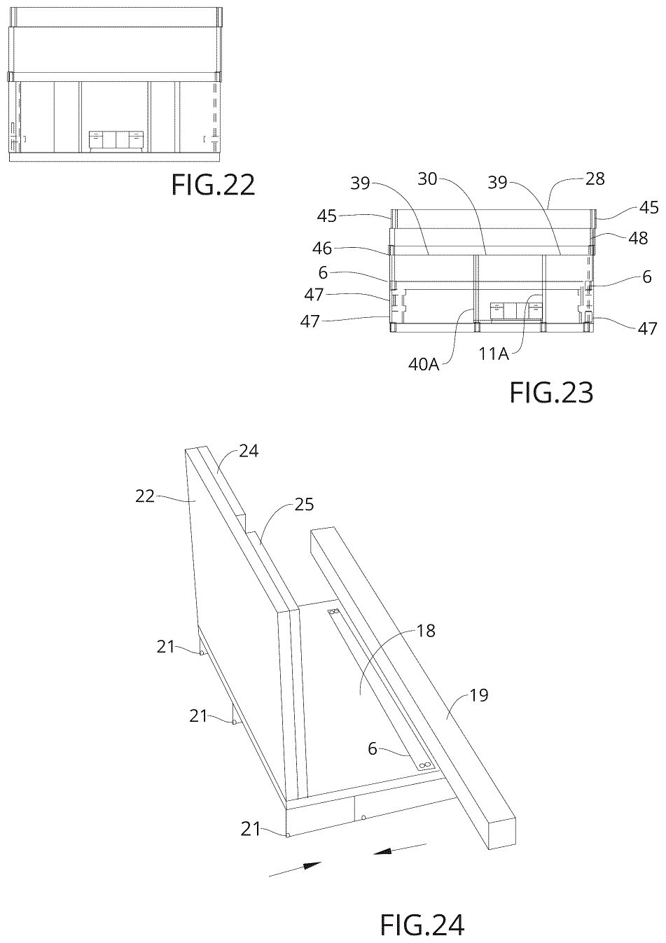

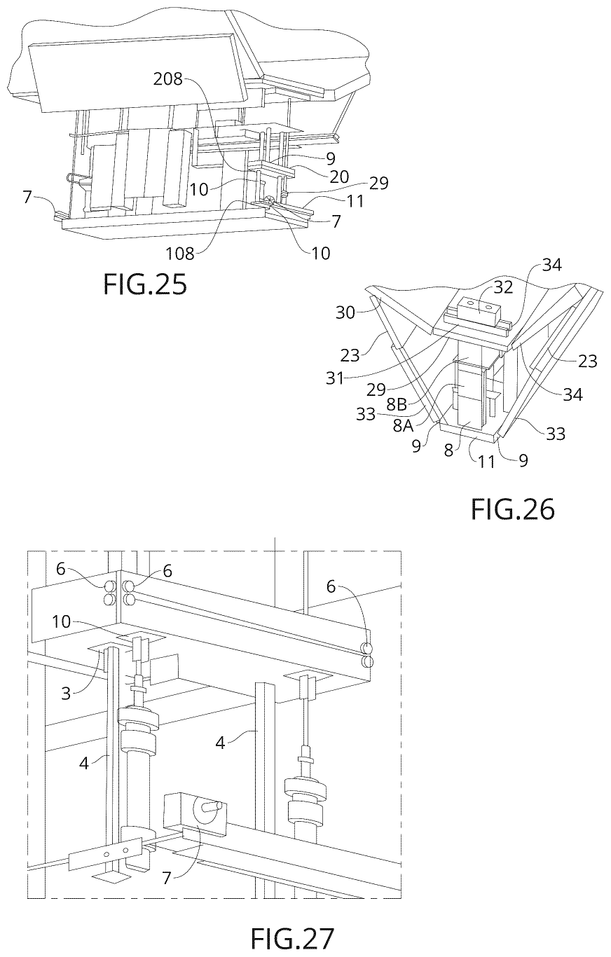

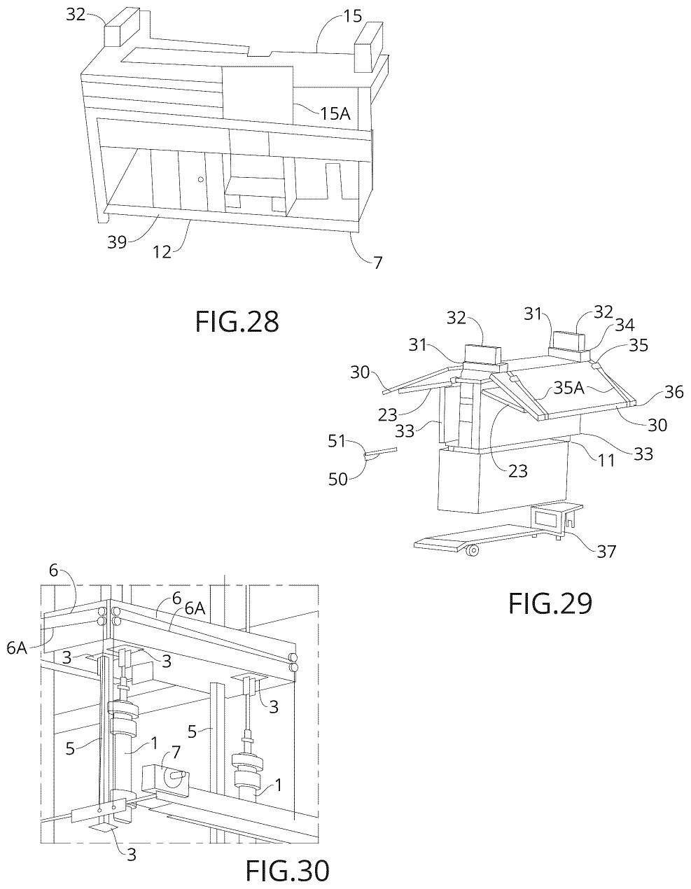

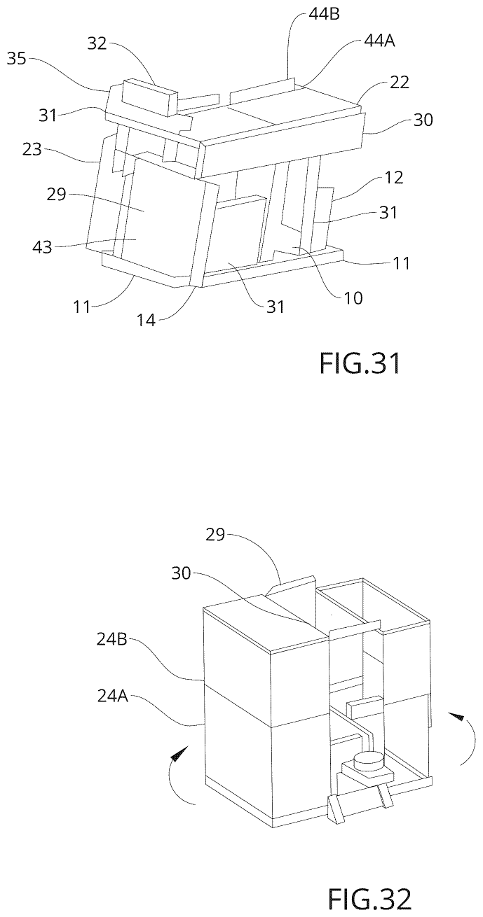

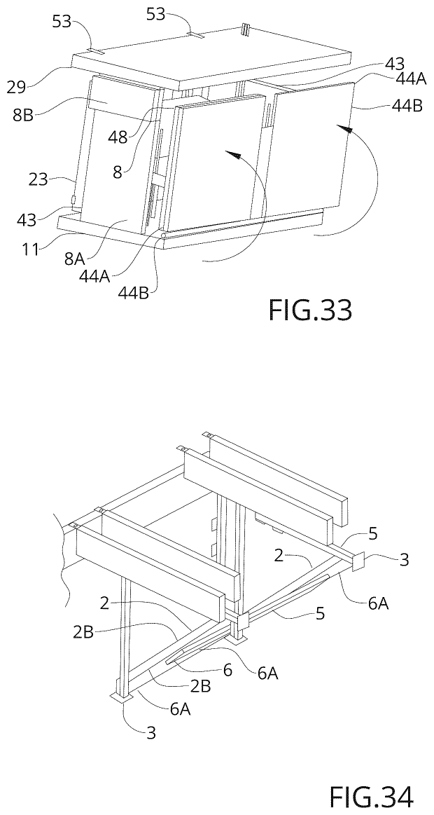

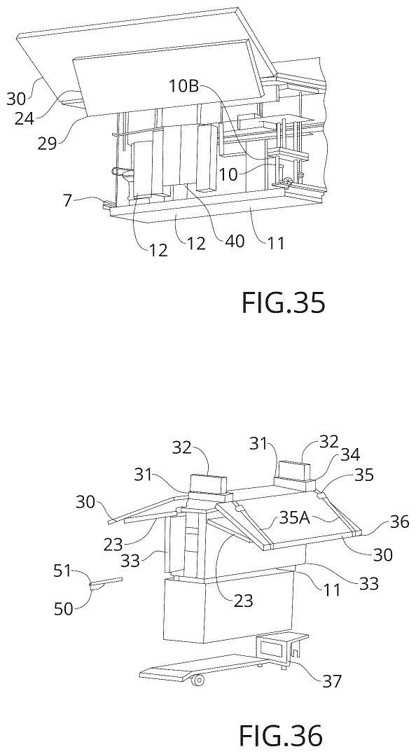

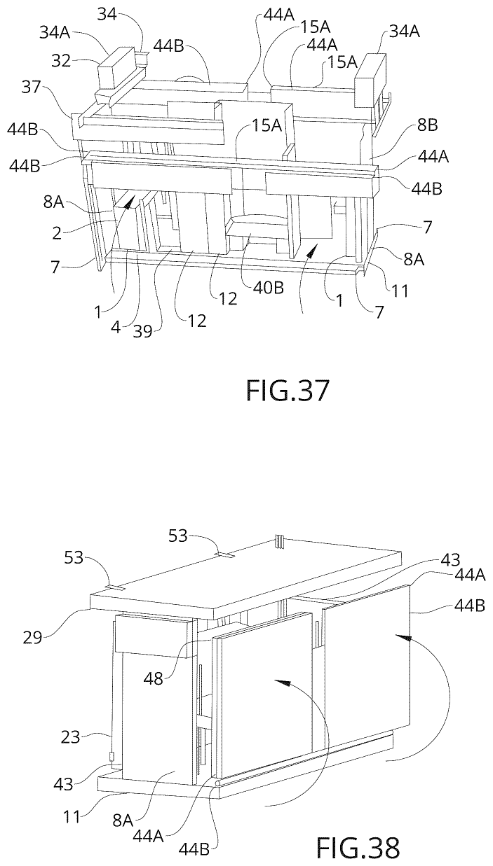

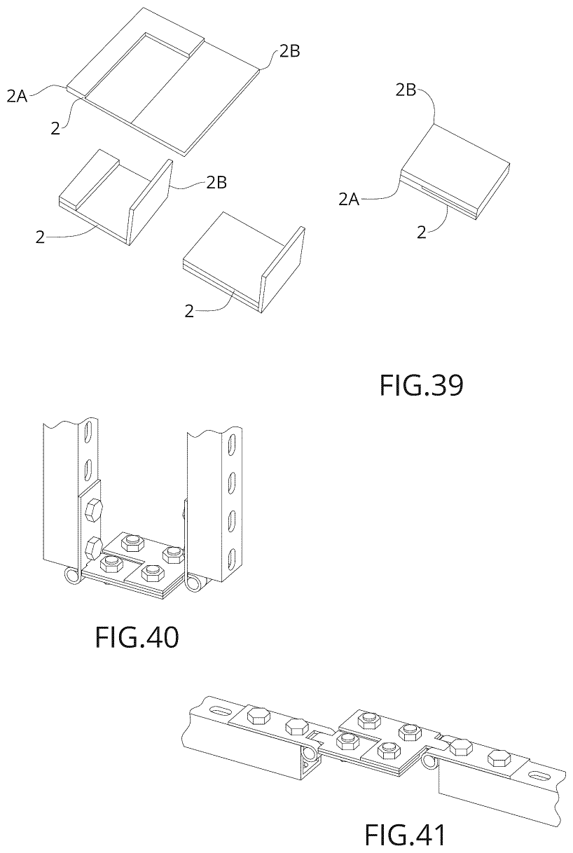

Referring to FIGS. 1 through 41, the subject disclosure provides a compact collapsible foldable enclosure with a telescopic lifting central structure or core having the following systemic components.

The telescopic lifting central core may support wall elements, floor elements, and directly or indirectly roof elements that further define the collapsible space of the foldable enclosure. The wall elements, floor elements, and roof elements may be independently configured to move between a folded condition and an unfolded condition. Each of these elements may include interchangeable paneling, frame members such as joists, and relevant fasteners.

In some embodiments, the telescopic lifting central structure provides parallelograms (bars) that engage the roof elements, the wall elements, and the floor elements so that they rotate in concert about the telescopic lifting central structure for compact folding and shipment. For instance, the wall elements may include a bi-folding framework that enables movement between the unfolded wall condition and the folded wall condition thereby flat-packing the wall elements and the floor elements in a stacked orientation for compact shipping.

Attachment points interconnect the respective wall elements and the floor elements and the wall elements and the roof elements. In some embodiments, heavy-duty offset hinges define the attachment points at the folding wall-to-floor and wall-to-roofing connections enabling continuous 360-degree full un-interrupted rotation of the connected elements.

The subject disclosure contemplates use of retractable strut channel assemblies enable installing add-on retractable spaces on both sides of the foldable enclosure to reduce the overall footprint of the foldable enclosure during storage when its constituent elements are in their respective folded conditions, while also enabling maximum floor space in the unfolded condition of the operable enclosure.

Extendable and retractable linear actuators mounted on the roof element of the foldable enclosure, in some embodiments interconnected to an upper portion of the central core, thereby enabling retraction and extension of the connected upper end wall elements for lowering the enclosure central core.

The subject disclosure contemplates the use of rotating telescopic strut channel posts with wheel strut trolleys attached to the bottom of folding floor elements, wherein the rotating telescopic strut channel posts enable free rotation of the floor elements to, in some embodiments, a concrete floor slab or sloped terrain as applies for varying site conditions for sturdy uniform landing of the unfolding floor elements.

Installation of heavy-duty hinges along the pivoting frame of the roof elements (e.g., clearstory roof mounted components) allows for pivoting the component downward into the open inner core space of the upper central core for compact shipment.

Fundamentally, the balanced lifting central core is attached to the on-folding sequence of rotating roof and floor elements that rotate about the upper and lower portions of the central cores. Transversely the linear retractable roof elements mounted to the upper portion of central core are used to extend and retract the upper-end wall elements of the lifting central core clear of the lower-end wall elements when raising and lowering the balanced upper portion of central core for compact shipment.

The heavy-duty linear actuator banks mounted at the ends of the lower portion of the central core act in unison with the parallelogram (bar) for balanced lifting of the enclosure's upper central core. The offset-hinged floor-to-wall connected elements work independent of the lifting of the unit's upper central core, the lateral retracting strut channel frames of the retractable folding panel spades, the roof-mounted linear actuators, and the telescopic extendable strut floor elements (e.g., interconnection of elemental joist posts and frame members).

The subject disclosure may be factory-assembled on a framing table with the use of electric and pneumatic power wrenches and associated tools. The components listed above may be essential or critical for the complete folding and unfolding of the unit for compact shipment.

The subject disclosure can be used for dwelling, recreation, vacation, military barracks, and command centers. Perhaps the most beneficial use would be for pre-assembling the hinged-paneled unit in a manufacturing plant, folding the enclosure, and loading the folded unit into the cargo bay of a NASA space shuttle to be launched into outer space orbit for compact shipment and further unfolding for use to modify and expand the International Space Station.

Additionally, the subject disclosure can be used as a basis for the development of a robotically controlled foldable structure with the use of remote-controlled heavy-duty rotary and linear electric actuators. Also, the subject disclosure can be used to produce military, commercial, utility, and recreational structures.

Furthermore, the present invention embodies an improvement in a compact folding space enclosure with a vertically retractable lifting upper central core with laterally connected wall panels, wherein the introduction of heavy-duty electric rotary and linear actuators and the use of parallelograms (bars) to overcome the challenges of balanced lifting of the heavy central core with attached roof, wall and floor panels in both earth-bound and to a significantly lesser extent the earth's orbit and solar applications.

The challenges of lifting the central core and the rotation of the buildings hinged outer floor, by way of the offset hinge(s) 14, wall and roof panels are almost non-existent in orbital and outer space conditions. The inclusion of offset heavy-duty strut hinge 14 produces new and unexpected results. The lifting of the vertically retractable central core to a height of four feet is achieved by use of dual stage lifting with the use stacked heavy-duty linear actuators with up to two feet vertical strokes is achieved with the aid of parallelograms (bars) attached to the end frames of the fixed attic floor/ceiling panels of the central core and attached to the central core floor by means of cables for balanced and uniform lifting on both the lateral and longitudinal axis.

Again, the challenges of rotating wall and roof panels by use of modified hinge arrangements are overcome with offset heavy-duty strut hinges 14 that include metal stiffener extensions to overcome the challenges of sustained connectivity in full hinged rotation of 360-degrees and the use of heavy-duty electric rotary actuators to achieve continuity and continuous rotation through pivotal conditions.

The challenge of moving the vertically pivoted upper end core wall panels is overcome using pairs of linear electric actuators attached to the celling of the central core to extend the upper end wall panel clear of the lower end wall panel when lowering the Central Core.

The limitations of usable floor space are overcome by the use of extendable and foldable floor, wall and roof panels on trolley moving strut channel frames to and from the undersides of the central core floor frame with a balancing parallelogram (bar) guide fastened to the fixed frame by means of wire cables to form both bedroom and foyers spaces or other such desired accessory spaces at the lateral sides of wall panels of the previous art.

The challenge of lifting the and lowering the roof, wall and central core is overcome by using electric (chain) hoists attached to metal framed fulcrums with intermittently filled water tanks mounted atop retractable strut channel assemblies that when tanks are full lift and lower the hinged series of panels in a rotary manner about the central core. The hoist frame assembly is mounted on both ends of the hoist fulcrum assembly and moves laterally to alternately clear both sides of the roof's edge to enable rotary lifting of the panels at separate times. The hooks of the chain hoist are connected to eyebolts mounted to a metal frame along the outer edge of the folding roof panel. The rotary and linear actuators in this invention are removable in either the erected or folded position.

As stated above, the need to overcome the challenges of heavy lifting of the central core for an earth-bound and to a significantly lesser extent earth orbit and solar applications are significantly reduced and practically non-existent. The gravitational force on Planet Mars is 38 percent of that of the Earth, yet the subject disclosure can be used as dwelling, an accessory dwelling, housing barrack, recreational structure, military barracks, commercial structure and so forth perhaps the most beneficial use of the subject disclosure will be, with enhanced level multi- actuator controls, remote control of the series to the extent feasible for a robotic telescopic lifting folding and unfolding of the unit with the aid of the robotic arm of the space shuttle robotic arm to unload the folded unit from the space shuttle transport bay to attach the present un-foldable unit for expansion and rehab to salvage the existing International Space Station.

The subject disclosure is a western framed panelized structure manufactured on a framing table by use of standard tools for assembly of panelized housing comprised of a central core with a floor, a central attic, a central attic add a central roof to which is attached as with panels as with the previous art by means of heavy duty strut hinges and remotely controlled heavy-duty electric rotary actuators to panelized manufactured roof panels to which is attached by mean of heavy duty strut hinges as in the previous art to panelized manufactured wall panels which are subsequently attached to rotating prefab manufactured floor by means of newly introduced to the present invention heavy duty offset metal hinges so arranged with offset rotating flanges adjacent to each other on axis hinge pins in a manner to allow the on-folding panelized wall panels with extended shallow metal strut channel stiffeners to make a full 360-degree rotation relative to the connected panelized manufactured on folding panels.

The challenge of lifting the upper central core in the subject disclosure is enhanced using a two-tiered bank of remotely controlled electric heavy-duty actuators and balanced lifting of the upper central core is achieved using parallelograms (bars) attached to both ends retractable ends of the attic pane joist frame of the central core with airline stainless steel cables. The challenge of expanding the resulting usable floor space on both sides of the foldable unit is achieved by installing folding panelized floor wall and roof panel assemblies on retractable strut trolley assemblies that move with the aid of electric boat winches and parallelograms to the walls of the respective folded side wall panels of the folded unit. Temporary support of the unfolded assembly of floor wall and roof panels on both sides of the unit is achieved by installing free-swinging upward rotating strut channel posts with folding diagonal brace tubes with sliding metal tubes couplings that cover the folding ends at the center of the diagonal brace. The uniform balanced movement of the sleeved metal coupling cover is controlled using parallelogram bars attached by means of airline cables to the end floor joist frame of the folding floor panel.

The challenge of shipping a shorter folded unit is overcome by installing heavy-duty electric rotary actuators aligned with heavy-duty strut metal hinges at mid-panel height on the end walls installed perpendicular to the unit's central core atop folding floor panels at sides of the central core.

The rotating floor panels as with the floor panels of the previous invention are subsequently attached to the floor panel along the fixed central core panel to form a contiguous hinged connection of rotating roof, wall and floor panels along the outer edges of the central core roof and floor panels. The hinged connections occur longitudinally along both sides of the unit's central core. The optional inclusion of the upper side wall panel does not allow for contiguous connection of the wall to the floor panel and would therefore require field assembly of the connection panels.

However, the use of the hinges to connect the on-folding upper and lower end wall panels as introduced in the present art can be rotated about the folding axis with the aid of remotely controlled heavy duty electric rotary actuators and electric powered hoists to erect and fold the unit accordingly. On folding ductwork extensions are compression sealed with rubber seals on metal flanges and fastened in field when the hinged unit is unfolded.

The subject disclosure overcomes the challenges of lifting of the central core, the rotation of the outer unit floor, wall and roof panels by using multiple dual stage heavy-duty linear electric actuators and heavy-duty rotary actuators to move the various floor, wall and roof panels of the previous art.

The subject disclosure uses parallelograms (bars) attached to the vertically moving end frames and the upper end of the wall panels and floor of the units' Central Core and the fixed channel frames of the expandable foldable unit panels by means of wire cables attached to fixed frames as described herein to form expanded accessory spaces for the unit of the previous art as described herein.

The ability to fold floor, wall and roof panels and telescopically raise lower the units central core allows the unit to be reduced in cubic volume and shipped inside the 16-foot diameter cargo bay of the NASA Space Shuttle as illustrated herein.

The subject disclosure uses linear electric actuators to move the upper end wall panels of the Upper Central Core when the Core is lowered in the unit folding sequence.

The subject disclosure uses the offset hinge assembly at the connection of folding wall to floor connections for a full 360-degree turning radius. The subject disclosure has foldaway furniture stored in alcoves of central core.

The subject disclosure has retractable folding floor, wall and roof panels with end wall panels attached to both ends of the central perpendicular side wall panel onto which end wall panels fold and this assembly folds down onto the hinged floor panel. This assembly then folds upward to move laterally as a retractable folded assembly. The folding hinged roof panel covering this assembly is extended down from the outer folding roof frame above retractable telescopic channels strut channels to then fold downward to fasten to cover the upward folding floor frame of the folded assembly during shipment by means of heavy-duty 4-hole hinges that also attach to unfolded wall panels when the unit is erected.

The subject disclosure utilizes metal and wood diagonal bracing in all folding roof, wall and floor panels with metal tie plates at intersecting diagonal and vertical framing members as with most trusts and joists in a vertical position when panels of the unit are in the folded position to resist racking provide the benefit of shear panel resistance as with wall panels a boxed trailer body in movement while being shipped to a site for unfolding of a panelized mobile unit.

The flashing membrane for the hinged folding roof, wall and floor panels of this folding unit is one that covers the entire surface of the hinged panel interface and is, in some embodiments, a 0.066 inch thick neoprene rubber membrane with at least two equal folding on-folding sides such that when panels are folded the membrane forms a continuous sealed channel with a compressible neoprene rubber bulb along the entire perimeter of the folded membrane. The membrane is designed to keep water and air out of the joint and thereby aid in weather-proofing the folded unit in conjunction with the weatherproof folded panels like that of a closed car door.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein. For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the subject disclosure and that modifications may be made without departing from the spirit and scope of the subject disclosure as set forth in the following claims.

What is claimed is:

1. A collapsible enclosure system for efficient transport and deployment, comprising:
a telescopic lifting core structure including an upper portion and a lower portion configured for balanced vertical retraction and extension;
a plurality of folding elements includes at least one folding wall element and one folding floor element, which are connected to the telescopic lifting core structure and configured to fold in two for compact shipment;
a plurality of actuators including at least one rotary actuator and at least one linear actuator positioned on the folding elements and the telescopic lifting core structure, wherein the actuators are arranged to provide continuous 360° rotation of the folding elements and balanced vertical movement of the telescopic lifting core structure;
a plurality of parallelogram linkage assemblies mechanically coupling the telescopic lifting core structure and the folding elements to facilitate simultaneous lateral retraction and vertical lifting of folding elements and the telescopic lifting core structure;
a plurality of retractable strut channel assemblies attached to the folding elements configured to enable installation of add-on retractable spaces for increased floor area; and
an offset-hinge interconnected between adjacent pairs of folding wall element and folding floor elements, wherein each offset-hinge works independent of the telescopic lifting core structure.

2. A method for deploying a compact collapsible folding enclosure for efficient transport and deployment, comprising:
providing a telescopic lifting core structure including an upper portion and a lower portion configured for balanced vertical retraction and extension;
providing a plurality of folding elements, including at least one folding wall element and one folding floor elements, connected to the telescopic lifting core structure and configured move between a folded condition for compact shipment and an unfolded condition for defining the enclosure;
actuating a plurality of heavy-duty rotary actuators and linear actuators arranged on the folding elements and the telescopic lifting core structure to facilitate continuous 360° rotation of the folding elements and balanced vertical movement of the telescopic lifting core structure;
engaging a plurality of parallelogram linkage assemblies to mechanically couple the telescopic lifting core structure and the folding elements, facilitating simultaneous lateral retraction and vertical lifting of enclosure components;
engaging a plurality of retractable strut channel assemblies attached to the folding elements to enable installation of add-on retractable spaces for increased floor area of the enclosure; and
engaging an offset-hinge interconnected between each adjacent pair of folding wall element and folding floor elements, wherein each offset-hinge works independent of the telescopic lifting core structure.

3. The method of claim 2, wherein banks of multiple heavy-duty electric linear actuators mounted at the lower floor on both ends of the central core are configured to overcome the challenges of vertical telescopic lifting of the central core as and a parallelogram lateral displacement of end wall panels of the upper central core and the later movement of collapsible wall, roof and floor panels.

4. The method of claim 3, wherein heavy-duty electric rotary actuators are attached along and in alignment with the hinge axis of pivotally connecting floor, floor wall and roof panel parallel to the central core and on bi-folding end wall panels mounted on folding outer core floor panels perpendicular to the central core on both ends of the unit.

5. The method of claim 4, further comprising installing heavy-duty electric rotary actuators aligned with heavy-duty strut metal hinges at mid-panel height on the end walls installed perpendicular to the central core atop folding floor panels at sides of the central core floor panel to enable folding enable folding of the end wall panels to achieve shortening the overall length of the folded unit.

6. The method of claim 5, wherein a parallelogram bar is installed on the vertically lifting end joist frame of the attics central core for balanced lifting of the central core with wire cables at the both ends of fixed strut frame at central core floor and at the upper end core walls, and a parallelogram installed below the moving end floor joist of the laterally extending room joist frame an attached to the fixed floor frame below at the central core.

7. The method of claim 6, wherein the use of offset heavy-duty strut off set hinge and flange stiffener assembly to allow for a full 360-degrees continuous rotation of the on folding floor-to-wall hinged panel connection with the aid of heavy-duty rotary actuator.

8. The method of claim 7, further comprising:
unfolding a transportable space enclosure mounted on a lowbed trailer in that back-to-back extendable strut channels post columns with trolleys attached to the base of joist framing with heavy-duty strut hinges in at least two rows at approximately two feet on center in such manner that they free swing downward to stand vertical until strut base anchor plates with open faces are slid into place at each post as a temporary means of supporting the unit floor, where shear panels are then field installed in both lateral and longitudinal directions; and
uniformly cutting strut column posts to a length of approximately fourteen inches extend from the hinge fastened to bottom of the unfolded floor joist frame to a leveled pre-installed concrete slab or sloped terrain on site on both sides of the unfolded unit's central core.

9. The method of claim 8, wherein the lifting and lowering of the roof, wall and floor panels about the central core via electric chain hoists attached to metal framed fulcrums with intermittently filled water tanks mounted atop retractable strut channel assemblies that when tanks are full will lift and lower the hinged series of panels in a rotary manner about the central core, wherein he hoist frame assembly is mounted on both ends of the hoist fulcrum assembly and move laterally to alternately clear both sides of the roof's edge to enable rotary lifting of the panels at separate times, and wherein the hooks of the chain hoist are connected to eyebolts mounted to a metal frame along the outer edge of the folding roof panel.

10. The method of claim 9, wherein the unit has retractable folding floor, wall and roof panels with end wall panels assemblies are attached to both ends of the central perpendicular side wall panel onto which the end wall panels fold and this assembly then folds down onto the hinged floor panel, wherein the wall and floor panel assembly then folds upward to move laterally as a retractable folded assembly. The folding hinged roof panel covering this assembly is extended down from the outer folding roof frame above on retractable telescopic channels struts channels extending into the core of the lower folding panel, and then folding downward to fasten to cover the upward folding floor frame of the folded assembly during shipment by means of heavy-duty hinges that also attach to unfolded wall panels when the unit is erected.

11. The method of claim 10, wherein a rotating extending fold-a-way panel folded panel assembly support post is attached to folding floor panel with folding diagonal bracing having retractable parallelograms attached to two or more upper folding diagonal steel brace channel segments which is controlled by electric linear actuators with the extending end of the actuator that moves a tubular steel channel vertically to cover the post support frame cover the folding ends of the diagonal brace to form a locked extended bracing when the floor support frame post is unfolded in a manually operated coupling for a locked brace assembly, wherein the wire ends of the airline cables of the parallelogram are attached to the opposite ends of the strut frame post supporting both ends of the folding outer floor frames.

12. The method of claim 11, wherein the flashing membrane for the hinged folding roof, wall and floor panels of this folding unit are those that cover the entire surface of the hinged panel interface and is less-than-one-inch thick neoprene rubber membrane with at least two equal folding on-folding sides such that when panels are folded the membrane forms a continuous sealed channel with a compressible neoprene rubber bulb along the entire perimeter of the folded membrane, wherein the membrane is designed to keep water and air out of the joint and thereby aid in weather-proofing the folding unit in conjunction with the weather proof folded d panels similar to that of a closed car door, wherein the folded unit is to be covered with a durable heavy-duty rubber membrane during shipment on a low bed trailer.
